(19) United States
(12) Patent Application Publication
(10) Pub. No.: US 2026/0074354 A1
(43) Pub. Date: Mar. 12, 2026

(54) BATTERY MODULE AND BATTERY PACK HAVING THE SAME

(71) Applicant: SK ON CO., LTD., Seoul (KR)

(72) Inventor: Jin Po PARK, Daejeon (KR)

(21) Appl. No.: 19/303,366

(22) Filed: Aug. 19, 2025

(30) Foreign Application Priority Data
Sep. 9, 2024 (KR) 10-2024-0122514

(51) Int. Cl. H01M 50/30; H01M 50/178; H01M 50/211; H01M 50/264; H01M 50/507; H01M 50/593

(52) U.S. Cl. CPC H01M 50/30; H01M 50/178; H01M 50/211; H01M 50/264; H01M 50/507; H01M 50/593

(57) ABSTRACT

A battery module according to an embodiment of the present disclosure may include: at least one battery cell in which at least one electrode lead thereof is exposed to the outside of an outer material including an electrode assembly accommodating region and a terrace region; at least one busbar assembly connected to the at least one electrode lead; a housing accommodating the plurality of battery cells and the at least one busbar assembly; and at least one blocking member disposed to face at least one of the at least one electrode lead or the terrace region.

### CROSS-REFERENCE TO RELATED APPLICATION(S)

This patent document claims the priority and benefits of Korean Patent Application No. 10-2024-0122514 filed on Sep. 9, 2024, the disclosure of which is incorporated herein by reference in its entirety.

### TECHNICAL FIELD

The present disclosure relates to a battery module and a battery pack having the same.

### BACKGROUND

Batteries are widely used in small electronic devices such as mobile phones and laptop computers as well as medium and large mechanical devices such as electric vehicles (EV), and have the advantage of being rechargeable and reusable.

An electrode assembly may be configured with an electrode plate including a cathode plate and an anode plate, and a separator separating the cathode plate and the anode plate. An electrode assembly manufactured in a stack type, a stack-folding type, a roll type, or the like, may be stored in a case selected according to the intended use thereof, such as a pouch type, a square type, a cylindrical type, or the like, and an electrolyte may be injected thereinto, and then the case may be sealed to manufacture a battery cell.

A plurality of battery cells may be stored in a housing, and a plurality of battery cells may be connected to a busbar to form a battery module. A plurality of battery modules may form a battery pack.

Gas may be generated during use of a battery module and/or a battery pack, and such gas should be efficiently processed.

### SUMMARY

According to an aspect of the present disclosure, a battery module and a battery pack having improved venting efficiency are provided.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

A battery module according to an embodiment of the present disclosure may include: at least one battery cell in which at least one electrode lead thereof is exposed to the outside of an outer material including an electrode assembly accommodating region and a terrace region; at least one busbar assembly connected to the at least one electrode lead; a housing accommodating the plurality of battery cells and the at least one busbar assembly; at least one blocking member disposed to face at least one of the at least one electrode lead or the terrace region.

In an embodiment, the at least one blocking member may be connected to the at least one busbar assembly, and may face the at least one electrode lead and the terrace region.

In an embodiment, the at least one blocking member may include: a support region connected to the at least one busbar assembly; and a protruding region protruding in a direction oriented from the support region toward the electrode assembly accommodating region.

In an embodiment, in the protruding region, a maximum width in a cross-section of the battery cell in a thickness direction may be narrower than a width of the support region.

In an embodiment, in the protruding region, a width in a cross-section of the battery cell may decrease in a thickness direction toward the electrode assembly accommodating region.

In an embodiment, the at least one blocking member may be formed of a material having electrical insulation.

In an embodiment, the at least one busbar assembly may include: a busbar member connected to the at least one electrode lead; and a busbar plate supporting the busbar member and formed of a material having electrical insulation, and the at least one blocking member may be connected to the busbar plate and may protrude in a direction from the busbar plate toward the battery cell.

In an embodiment, the at least one blocking member may be spaced from the battery cell and may not be in contact with the battery cell.

In an embodiment, a height of the at least one blocking member may exceed a height of the at least one electrode lead.

In an embodiment, the housing may include at least one venting hole on a surface facing the at least one busbar assembly, and a height of the at least one venting hole in the housing may be greater than or equal to a height of the at least one busbar assembly.

In an embodiment, the housing may include: a first housing including the at least one venting hole and covering an upper portion of the plurality of battery cells; and a second housing coupled to the first housing and covering a lower portion of the plurality of battery cells.

In an embodiment, a contact region of the first housing and the second housing may face the at least one electrode lead.

In an embodiment, the battery module may further include a fastening member fixing the first housing and the second housing.

A battery pack according to an embodiment of the present disclosure may include: a pack case; and a battery module accommodated in the pack case, and the battery module may include: a plurality of battery cells in which at least one electrode lead thereof is exposed to the outside of an outer material including an electrode assembly accommodating region and a terrace region; at least one busbar assembly connected to the at least one electrode lead; a housing accommodating the plurality of battery cells and the at least one busbar assembly; and at least one blocking member disposed to face at least one of the at least one electrode lead and the terrace region.

In an embodiment, the pack case may include at least one pack venting hole.

According to an aspect of the present disclosure, a battery module and a battery pack having improved venting efficiency are provided.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic perspective view of a battery module according to an embodiment of the present disclosure.

FIG. 2 is a schematic view of a cross-section taken along line A-A′ of FIG. 1.

FIG. 3 is a schematic perspective view of a battery cell according to an embodiment of the present disclosure.

FIG. 4 is a schematic view of a battery cell and a blocking member according to an embodiment of the present disclosure, which is a front view.

FIG. 5 is an enlarged view of ‘B’ of FIG. 2.

FIG. 6 is a schematic perspective view of a battery module according to another embodiment of the present disclosure.

FIG. 7 is a schematic view of a portion of a cross-section of the battery module illustrated in FIG. 6.

FIG. 8 is a schematic view of a coupling state between an electrode lead and a busbar member according to an embodiment of the present disclosure.

FIG. 9 is a schematic view of a portion of a cross-section of a battery module according to another embodiment of the present disclosure.

FIG. 10 is a schematic perspective view of a battery pack according to an embodiment of the present disclosure.

### DETAILED DESCRIPTION

In order to assist in understanding the description of an embodiment of the present disclosure, elements described with the same symbol in the attached drawings are the same elements. Some components in the attached drawings are exaggerated, omitted, or schematically illustrated, and the size of each component does not completely reflect an actual size thereof.

Additionally, in order to clarify the gist of the present disclosure, descriptions of elements and techniques well known by conventional techniques are omitted, and hereinafter, the present disclosure will be described in detail with reference to the attached drawings.

Hereafter, an X-axis illustrated in the drawing is a thickness direction of a battery cell 110 or a stacking direction of a plurality of battery cells 110, a Y-axis is a width direction of the battery cell 110, and a Z-axis is a height direction of the battery cell 110. However, this is a direction arbitrarily set for the convenience of understanding, and the directions may be changed.

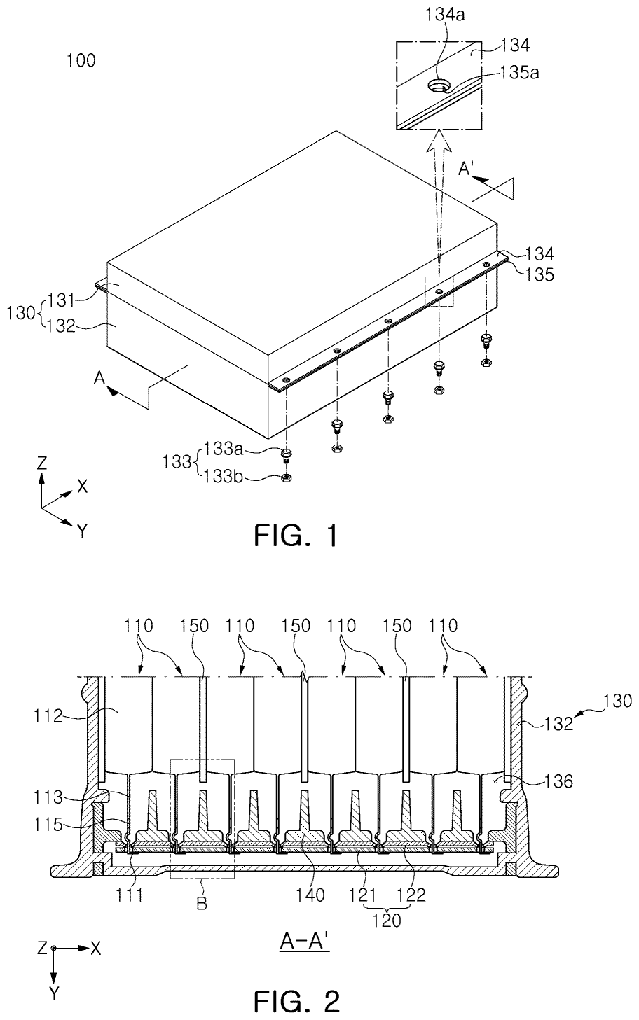

FIG. 1 is a schematic perspective view of a battery module 100 according to an embodiment of the present disclosure.

As illustrated in FIG. 1, the battery module 100 according to an embodiment of the present disclosure may include a housing 130 forming an exterior. The housing 130 may accommodate a plurality of battery cells 110 therein.

In an embodiment, the housing 130 may include a first housing 131 and a second housing 132. The first housing 131 and the second housing 132 may be coupled to each other to accommodate a plurality of battery cells 110.

For example, the first housing 131 may cover an upper portion of the plurality of battery cells 110 in a +Z-direction, and the second housing 132 may be coupled to the first housing 131 and may cover a lower portion of the plurality of battery cells 110 in the −Z-direction.

In an embodiment, the first housing 131 and the second housing 132 may be coupled or fixed by a fastening member 133.

For example, the fastening member 133 may include a bolt 133a penetrating through the first housing 131 and the second housing 132 and a nut 133b coupled to the bolt 133a. However, the type of the fastening member 133 is not necessarily limited by the present disclosure.

Additionally, in an embodiment, the first housing 131 may include a first flange 134, and the second housing 132 may include a second flange 135 in contact with the first flange 134.

The first flange 134 may include a first coupling hole 134a which is a through-hole, and the second flange 135 may include a second coupling hole 135a which is a through-hole.

The first coupling hole 134a and the second coupling hole 135a face each other, and one bolt 133a may be inserted into one first coupling hole 134a and one second coupling hole 135a. An end of the bolt 133a may be fixed by the nut 133b. Accordingly, the first housing 131 and the second housing 132 may be fixed or coupled to each other. Conversely, the first housing 131 and the second housing 132 may be separated from each other by disassembling the bolt 133a and the nut 133b. Accordingly, the assembly efficiency of the battery module 100 may be improved, and the ease of maintenance of the battery module 100 may be improved.

In an embodiment, the first coupling hole 134a and the second coupling hole 135a may be provided in plural. In this case, the fastening member 133 may also be provided in plural.

FIG. 2 is a schematic view of a cross-section taken along line A-A′ of FIG. 1. In FIG. 2, the battery cell 110 and a pad member 150 are not illustrated in a cross-section, and the housing 130 has a cross-section of the second housing 132 illustrated therein.

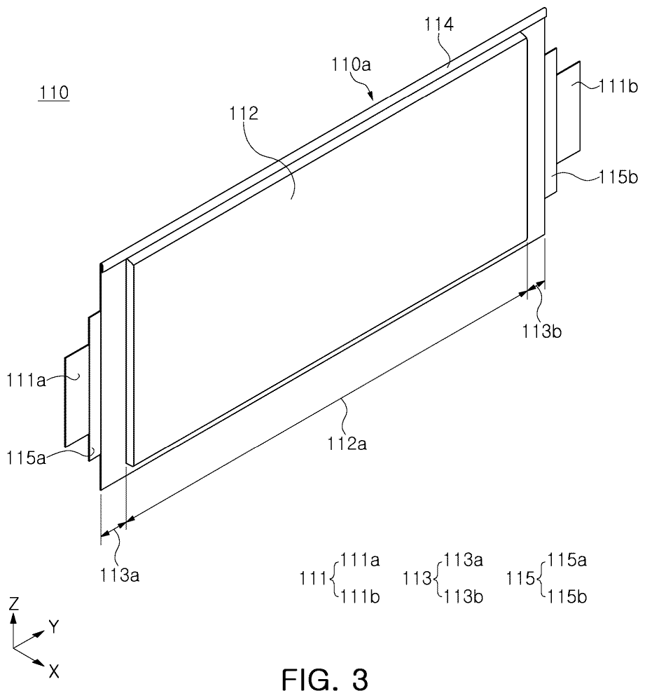

FIG. 3 is a schematic perspective view of a battery cell 110 according to an embodiment of the present disclosure.

As illustrated in FIGS. 1 to 3, a battery module 100 according to an embodiment of the present disclosure may include at least one battery cell 110 having at least one electrode lead 111 exposed to the outside of an outer material 110a including an electrode assembly accommodating region 112 and a terrace region 113, at least one busbar assembly 120 connected to the at least one electrode lead 111, a housing 130 accommodating the plurality of battery cells 110 and the at least one busbar assembly 120, and at least one blocking member 140 disposed to face at least one of the at least one electrode lead 111 or the terrace region 113. In an embodiment, at least one battery cell includes a plurality of battery cells.

At least one busbar assembly 120 may be electrically connected to at least one electrode lead 111. At least one busbar assembly 120 may include a plurality of busbar assemblies 120.

In an embodiment, at least one blocking member 140 may include a plurality of blocking members 140.

The housing 130 may include an accommodating space 136 in which a plurality of battery cells 110, a busbar assembly 120 and a blocking member 140 are accommodated. For example, the second housing 132 may include the accommodating space 136, and the first housing 131 coupled to the second housing 132 may also include the accommodating space 136 corresponding to the accommodating space 136 provided in the second housing 132.

In an embodiment, the plurality of battery cells 110 may be stacked in a thickness direction (X-direction) of the battery cells 110.

Additionally, as an example, the pad member 150 may be disposed between a plurality of battery cells 110. The pad member 150 may provide surface pressure to the battery cell 110 or may serve to cool the battery cell 110. The number of pad members 150, an arrangement position of the pad members 150, a material of the pad members 150, and the like, are not necessarily limited by the present disclosure.

With reference to FIG. 3, the battery cell 110 according to an embodiment of the present disclosure will be described. The battery cell 110 may be, for example, a pouch-type battery cell 110. The battery cell 110 may have a sealed structure by folding the outer material 110a so that both ends thereof touch each other, and heat-welding an overlapping region in a state in which the remaining three edges, excluding an edge at which a folded line is formed in the outer material 110a, overlap each other.

The battery cell 110 may include an electrode lead 111 exposed to the outside of the outer material 110a, and a lead film 115 electrically insulating the electrode lead 111 and the outer material 110a. For example, the electrode lead 111 may be provided in plural. The electrode lead 111 may include a first electrode lead 111a and a second electrode lead 111b, and the lead film 115 may include a first lead film 115a and a second lead film 115b.

In an embodiment, one of the plurality of busbar assemblies 120 may be electrically connected to the first electrode lead 111a of each of the plurality of battery cells 110, and another busbar assembly 120 may be electrically connected to the second electrode lead 111b of each of the plurality of battery cells 110.

In an embodiment, at least one blocking member 140 may be provided in one of the busbar assemblies 120, and at least one blocking member 140 may also be provided in another busbar assembly 120.

The first lead film 115a may insulate the first electrode lead 111a and the outer material 110a, and the second lead film 115b may insulate the second electrode lead 111b and the outer material 110a. In an sealed outer material 110a, the first electrode lead 111a and the second electrode lead 111b may be exposed to the outside of the outer material 110a.

A side sealing portion 114 disposed parallel to a width direction (Y-direction) of the battery cell 110 in the outer material 110a may be rolled or folded and fixed to an outer surface of the outer material 110a. In an embodiment, the outer material 110a may be in the form of a film in which polyethylene terephthalate (PET), nylon, and aluminum are stacked.

The outer material 110a may include an electrode assembly accommodating region 112 in which an electrode assembly is accommodated. An electrode assembly including a cathode plate, an anode plate and a separator may be accommodated in the electrode assembly accommodating region 112, and an electrolyte may be accommodated. The electrode assembly accommodating region 112 may be sealed. The electrode assembly accommodating region 112 may protrude in a X-direction.

The terrace region 113 may be a region formed on an outer surface of the outer material 110a. For example, the terrace region 113 may be a region adjacent to a region corresponding to the electrode assembly accommodating region 112, among the outer surfaces of the outer material 110a. Additionally, as an example, the terrace region 113 may be a region disposed adjacently to the electrode assembly accommodating region 112. Additionally, as an example, the terrace region 113 may be the remaining region of the outer material 110a excluding the region corresponding to the electrode assembly accommodating region 112 of the outer material 110a, or may be the remaining region of the outer surface of the outer material 110a excluding the outer surface of the outer material 110a corresponding to the electrode assembly accommodating region 112 from the outer material 110a. Additionally, as an example, the terrace region 113 may be a region that does not face or overlap the electrode assembly accommodated inside the outer material 110a in a thickness direction (X-direction) of the battery cell.

For example, the terrace region 113 may be a region exposed to the outer surface of the outer material 110a. The terrace region 113 may include a sealed region, which is a region in which the outer material 110a is sealed. In some cases, the side sealing portion 114 may be excluded from the terrace region 113. The side sealing portion 114 may be a region in which the outer material 110a is sealed by rolling or folding the outer material 110a at least once in a state of overlapping ends of the outer material 110a. The side sealing portion 114 may form a long side of the electrode assembly accommodating region 112 or a long side of the battery cell 110.

One terrace region 113 may be adjacent to on one side of the electrode assembly accommodating region 112 on the outer surface of the outer material 110a, and another terrace region 113 may be adjacent to the other side of the electrode assembly accommodating region 112 on the outer surface of the outer material 110a. The electrode assembly accommodating region 112 may be disposed adjacently to a plurality of terrace regions 113, or the plurality of terrace regions 113 may be disposed adjacently to the electrode assembly accommodating region 112.

The plurality of terrace regions 113 may include a first terrace region 113a adjacent to the electrode assembly accommodating region 112 in the −Y-direction, and a second terrace region 113b adjacent to the electrode assembly accommodating region 112 in the +Y-direction.

An inner surface of the first terrace region 113a may be provided with a sealed region of the outer material 110a, at least a partial region of the first electrode lead 111a, and at least a partial region of the first lead film 115a.

An inner surface of the second terrace region 113b may be provided with a sealed region of the outer material 110a, at least a partial region of the second electrode lead 111b, and at least a partial region of the second lead film 115b.

In an embodiment, the battery cell 110 may be a bidirectional battery cell, and may be a pouch-type battery cell.

A width 112a of the electrode assembly accommodating region 112 in the Y-direction in the battery cell 110 may be wider than a width 113a of the first terrace region 113a in the Y-direction and a width 113b of the second terrace region 113b in the Y-direction.

As illustrated in FIGS. 2 and 3, in an embodiment of the present disclosure, the blocking member 140 may be connected to the busbar assembly 120. Additionally, the blocking member 140 may face the electrode lead 111 and the terrace region 113.

In an embodiment, the blocking member 140 may be provided in plural. The plurality of blocking members 140 may be disposed in the first terrace region 113a and the second terrace region 113b.

In an embodiment, the plurality of battery cells 110 may be stacked or arranged so that the plurality of first terrace regions 113a face each other and the plurality of second terrace regions 113b face each other. The plurality of first terrace regions 113a may face each other in the X-direction, and the plurality of second terrace regions 113b may also face each other in the X-direction.

A plurality of blocking members 140 may be disposed between each pair of battery cells 110. For example, one blocking member 140 may be disposed between a pair of first terrace regions 113a of a pair of battery cells 110, and another blocking member 140 may be disposed between a pair of second terrace regions 113b of a pair of battery cells 110.

In this manner, the blocking member 140 may be interposed between a pair of terrace regions 113 of a pair of battery cells 110 adjacent to each other. However, the blocking member 140 may also be disposed between the terrace region 113 of the battery cell 110 disposed on the outermost side in the +X-direction and the −X-direction, among the plurality of battery cells 110 and the housing 130.

In an embodiment, the blocking member 140 may be spaced from the battery cell 110 and may not be in contact with the battery cell 110. For example, the blocking member 140 may be spaced from the outer material 110a and the electrode lead 111, and may not be in contact with the outer material 110a and the electrode lead 111.

The blocking member 140 may be supported by the busbar assembly 120 in the accommodating space 136. In an embodiment, the blocking member 140 may include a material having electrical insulation. Accordingly, interference between the blocking member 140 and the busbar assembly 120 may be prevented. Additionally, the electrical safety of the battery module 100 may be improved. For example, the blocking member 140 may be formed of a plastic having electrical insulation. For example, the blocking member 140 may include Modified Polyphenylene Oxide (MPPO) and polypropylene (PP-TD/GF). Accordingly, the insulation performance of the blocking member 140 may be improved. Additionally, the rigidity of the blocking member 140 may be increased. However, the type of the blocking member 140 is not necessarily limited by the present disclosure.

The blocking member 140 may prevent gas, for example, venting gas, from being transmitted to the plurality of battery cells 110. The blocking member 140 may prevent venting gas generated from one battery cell 110 from being transmitted to another battery cell 110 adjacent to the one battery cell 110.

In a thickness direction cross-section (X-Y plane) of the battery cell 110, the blocking member 140 may face at least a partial region of the electrode lead 111 of the battery cell 110 and at least a partial region of the lead film 115.

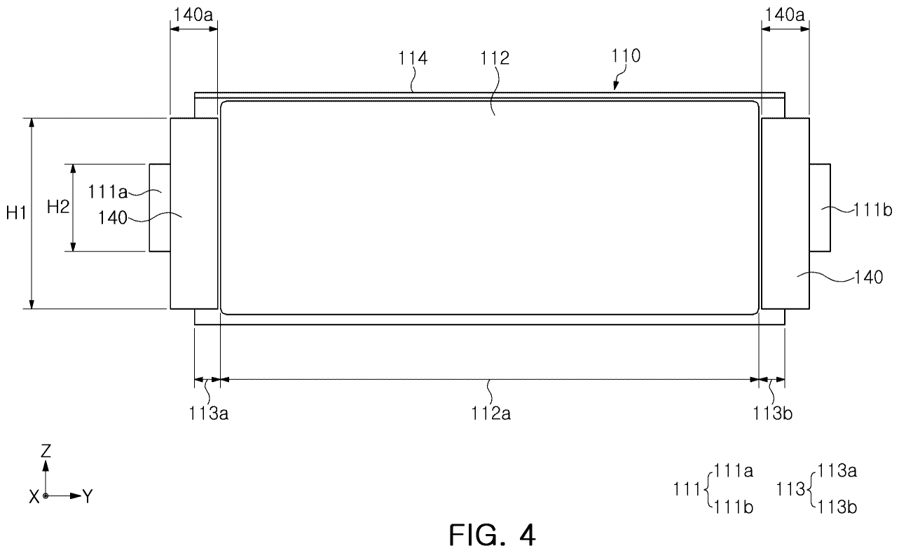

FIG. 4 schematically illustrates a battery cell 110 and a blocking member 140 according to an embodiment of the present disclosure, and is illustrated from a front view perspective.

As illustrated in FIG. 4, one blocking member 140 among the plurality of blocking members 140 may face at least a partial region of the first terrace region 113a and the first electrode lead 111a. Additionally, another blocking member 140 among the plurality of blocking members 140 may face at least a partial region of the second terrace region 113b and the second electrode lead 111b.

In an embodiment, a first height of the blocking member 140 in the Z-axis direction may be higher than a second height of the electrode lead 111 in the Z-axis direction. In this case, the second height may be a height of the first electrode lead 111a and a height of the second electrode lead 111b.

Additionally, a width 140a in the Y-axis direction of the blocking member 140 may be wider than a width of the first terrace region 113a in the Y-axis direction and wider than a width of the second terrace region 113b in the Y-axis direction. Accordingly, the venting gas may be easily blocked from being transmitted to the plurality of battery cells 110.

Specifically, the blocking member 140 may be disposed adjacent to an edge of the outer material 110a, the first electrode lead 111a and the second electrode lead 111b, so that the venting gas generated in a region adjacent to the edge of the outer material 110a, i.e., the sealing portion of the outer material 110a, may be easily blocked from being transmitted to other battery cells 110.

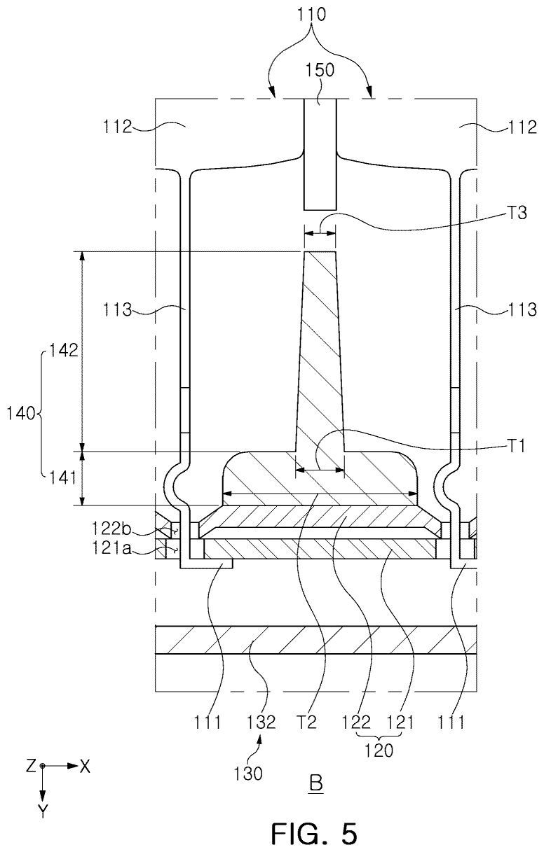

FIG. 5 is an enlarged view of ‘B’ of FIG. 2.

As illustrated in FIG. 5, in an embodiment of the present disclosure, the blocking member 140 may include a support region 141 connected to the busbar assembly 120 and a protruding region 142 protruding from the support region 141 in a direction oriented toward the electrode assembly accommodating region 112.

In an embodiment, the busbar assembly 120 may include a busbar member 121 connected to the electrode lead 111 and a busbar plate 122 supporting the busbar member 121 and including a material having electrical insulation. In this case, the blocking member 140 may be connected to the busbar plate 122 and may protrude from the busbar plate 122 in a direction oriented toward the battery cell 110.

For example, the support region 141 may be connected to the busbar plate 122. In some cases, the support region 141 may be fixed to the busbar plate 122 using an adhesive, a tape, or the like.

One side of the protruding region 142 may be connected to the support region 141 and the other side thereof may protrude in a direction oriented toward the electrode assembly accommodating region 112. The protruding region 142 may serve as a partition wall between the plurality of battery cells 110, and may suppress the transmission of venting gas between the plurality of battery cells 110. In this case, the venting gas may include flammable particles, and the like.

In an embodiment, at least a partial region of the protruding region 142 may be disposed on the same line as the pad member 150 in the Y-axis direction. The protruding region 142 may be spaced apart from the pad member 150.

In an embodiment, a maximum width T1 of the protruding region 142 in the thickness direction cross-section (X-Y plane) of the battery cell 110 may be narrower than a width T2 of the support region 141. In this case, the width thereof may be a width in the thickness direction of the battery cell 110, i.e., the X-axis direction. In this case, the width T2 of the support region 141 may be a maximum width of the support region 141. However, the minimum width of the support region 141 may also be wider than a maximum width T1 of the protruding region 142.

Accordingly, a contact region between the blocking member 140 and the busbar plate 122 may be increased. Accordingly, bonding force between the blocking member 140 and the busbar plate 122 may be improved.

On the other hand, since a volume of the blocking member 140 in the protruding region 142 may be reduced, unnecessary weight increase of the blocking member 140 may be suppressed. This may contribute to improving the energy density of the battery module 100.

Additionally, in an embodiment, a width of the protruding region 142 in the thickness direction cross-section of the battery cell 110 may decrease toward the electrode assembly accommodating region 112. The protruding region 142 has the widest width in the X-axis direction in a region in contact with the busbar plate 122, and this region may have the maximum width T1 of the protruding region 142. On the other hand, the protruding region 142 may have the thinnest width in an end disposed closest to the electrode assembly accommodating region 112. This region may be a minimum width T3 of the protruding region 142.

A width of the protruding region 142 in the X-axis direction may decrease linearly from the maximum width T1 to the minimum width T3. According thereof, the volume of the blocking member 140 may be minimized while maintaining the venting gas transmission function of the blocking member 140. Accordingly, a weight of the blocking member 140 may be relatively reduced, which may contribute to improving the energy density.

In an embodiment, the busbar member 121 may include a first slot 121a through which the electrode lead 111 penetrates, and the busbar plate 122 may include a second slot 122a facing the first slot 121a. The first slot 121a may be a hole formed in the busbar member 121, and the second slot 122a may be a hole formed in the busbar plate 122. The electrode lead 111 may be exposed to the outside of the busbar member 121 by penetrating through the first slot 121a and the second slot 122a, and an end of the electrode lead 111 may be in contact with the busbar member 121.

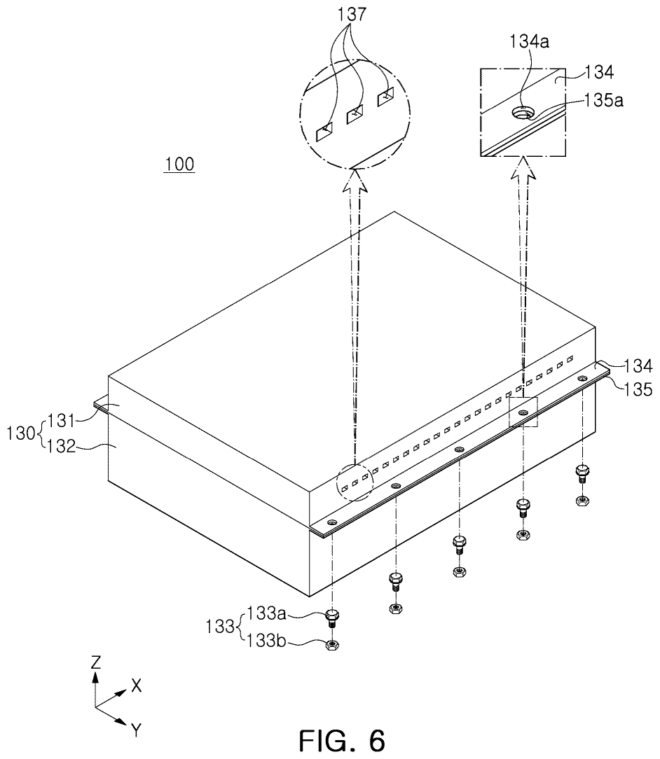

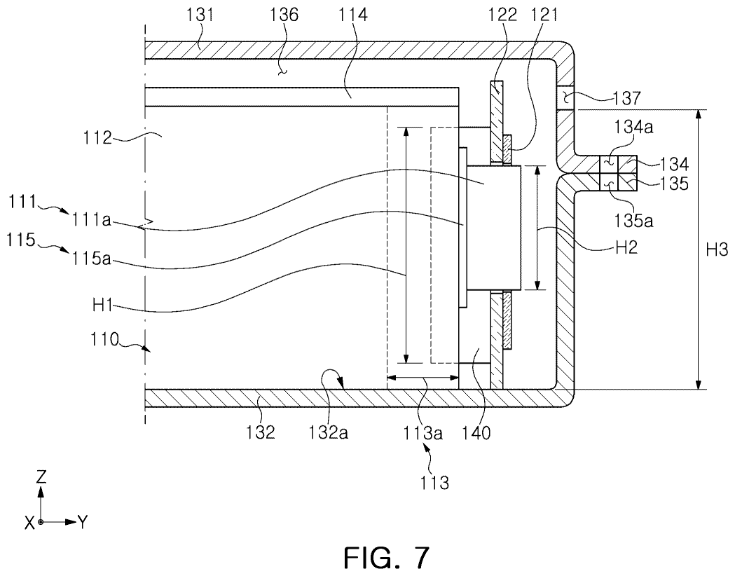

FIG. 6 is a schematic perspective view of a battery module 100 according to another embodiment of the present disclosure, and FIG. 7 is a schematic view of a portion of a cross-section of the battery module 100 illustrated in FIG. 6.

As illustrated in FIGS. 6 and 7, in another embodiment of the present disclosure, the housing 130 may include at least one venting hole 137 on a surface facing the electrode lead 111. For example, when the housing 130 is provided in plural and includes a first housing 131 and a second housing 132, at least one venting hole 137 may be provided in the first housing 131.

The first housing 131 may cover an upper portion of the battery cell 110 in the +Z-direction and may cover the side sealing portion 114 of the battery cell 110.

A coupling surface of the first housing 131 and the second housing 132 may be disposed on a side surface of the battery cell 110. In an embodiment, a contact region of the first housing 131 and the second housing 132 may be disposed on a side surface of the battery cell 110, and the contact region may face at least a partial region of the electrode lead 111.

As described above, the first housing 131 and the second housing 132 may be coupled to each other by inserting the fastening member 133 into the first coupling hole 134a of the first housing 131 and the second coupling hole 135a of the second housing 132.

In an embodiment, at least one vent hole 137 may include a plurality of vent holes 137. The plurality of vent holes 137 may be arranged in a parallel manner in a stacking direction (X-axis direction) of the battery cells 110 in the first housing 131. However, the number of vent holes 137 is not limited by the present disclosure.

In an embodiment, a height H3 of the at least one vent hole 137 in the housing 130 may be greater than or equal to a height of the electrode lead 111. In an embodiment, the height H3 of the at least one vent hole 137 in the housing 130 may be greater than or equal to a height of the at least one busbar assembly. For example, the height H3 of the at least one vent hole 137 in the housing 130 may be greater than or equal to a height of the busbar member 121.

The height H3 of the at least one vent hole 137 may be less than or equal to the height of the housing 130 in the Z-axis direction. For example, the height H3 of the at least one vent hole 137 may be less than or equal to a sum of a height of the first housing 131 in the Z-axis direction and a height of the second housing 132 in the Z-axis direction.

When at least one vent hole 137 includes a plurality of vent holes 137, the height H3 of the plurality of vent holes 137 in the Z-axis direction may be higher than a height H2 of the electrode lead 111. The height H3 of the vent hole 137 in the Z-axis direction may be equal to a distance or a height from a lower surface 132a of the second housing 132 in the −Z-direction to the vent hole 137 in the Z-axis direction.

In an embodiment, a height H1 of the blocking member 140 in the Z-axis direction may exceed the height H2 of the electrode lead 111. In an embodiment, the height H1 of the blocking member 140 in the Z-axis direction may exceed the height H2 of the electrode lead 111 and may be less than or equal to the height H3 of the venting hole 137.

Accordingly, while blocking the venting gas from being transmitted to other battery cells 110, the venting gas may be induced to be discharged through the venting hole 137. The venting gas may be discharged to the outside of the housing 130 through the venting hole 137. Accordingly, a discharge path of the venting gas may be set to an upper portion of the electrode lead 111 in the +Z-direction.

In FIG. 7, the venting hole 137 is illustrated as facing the first electrode lead 111a, but the first housing 131 may also have a venting hole 137 in a position facing the second electrode lead 111b.

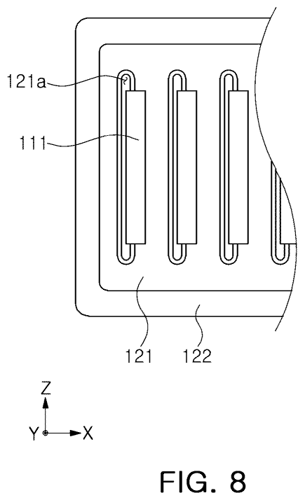

FIG. 8 schematically illustrates a coupling state between an electrode lead 111 and a busbar member 121 according to an embodiment of the present disclosure.

As illustrated in FIG. 8, in an embodiment of the present disclosure, the busbar member 121 may be supported by the busbar plate 122. The electrode lead 111 may penetrate through the first slot 121a of the busbar member 121 and may be exposed to the outside of the busbar member 121. The electrode lead 111 may be folded or bent and may thus be in close contact with the busbar member 121. In this case, the folded region or bent region of the electrode lead 111 may be welded to the busbar member 121.

Electrical connection between the busbar member 121 and the electrode lead 111 may be performed in this manner, which is according to an embodiment of the present disclosure, and other methods may be used to connect the electrode lead 111 and the busbar member 121.

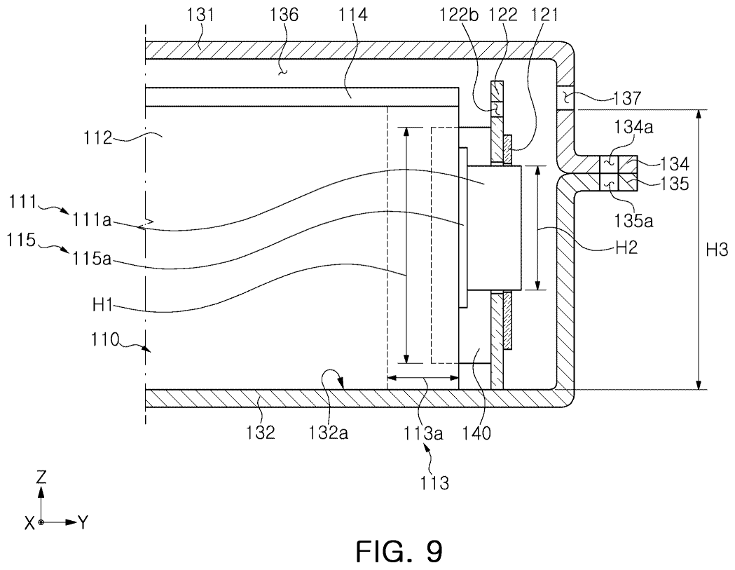

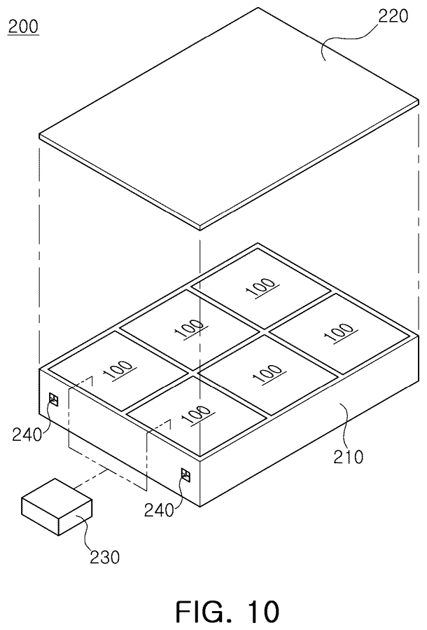

FIG. 9 schematically illustrates a portion of a cross-section of a battery module 100 according to another embodiment of the present disclosure.

As illustrated in FIG. 9, in another embodiment of the present disclosure, the busbar plate 122 may include an internal venting hole 122b facing the venting hole 137. The internal venting hole 122b may overlap the venting hole 137 formed in the housing 130 in the Y-axis direction.

The internal venting holes 122b may be provided in plural in the busbar plate 122, and when there are a plurality of venting holes 137, the number of internal venting holes 122b may be provided to be equal to the number of venting holes 137.

The internal venting holes 122b may allow the venting gas to quickly flow into the venting holes 137 formed in the housing 130, and may facilitate the rapid discharge of the venting gas.

The venting gas generated in the battery cell 110 may be discharged to the outside of the battery module 100 through the first slot 121a, the second slot 122a, the internal venting holes 122b and the venting holes 137 of the busbar assembly 120 described above.

Additionally, as an example, a venting path of the venting gas of the present disclosure may be an upper portion of the electrode lead 111 in the +Z-direction. Additionally, the venting path of the present disclosure may be formed as an upper portion of a contact region between the first housing 131 and the second housing 132 in the +Z-direction.

FIG. 10 is a schematic perspective view of a battery pack 200 according to an embodiment of the present disclosure.

As illustrated in FIGS. 1 to 3 and FIG. 10, the battery pack 200 according to an embodiment of the present disclosure may include a pack case 210 and a battery module 100 accommodated in the pack case 210, and the battery module 100 may include a plurality of battery cells 110 in which electrode leads 111 thereof are exposed to the outside of an exterior material 110a including an electrode assembly accommodating region 112 and a terrace region 113, a busbar assembly 120 connected to the electrode lead 111, a housing 130 accommodating the plurality of battery cells 110 and the busbar assembly 120, and at least one blocking member 140 disposed to face at least one of the electrode lead 111 and the terrace region 113, and the battery modules 100 may be provided in plural.

The battery module 100 may be a battery module 100 according to any one of the embodiments described above.

As illustrated in FIGS. 1 to 10, the battery modules 100 may be provided in plural in the pack case 210. The plurality of battery modules 100 may be connected to each other by a busbar assembly 120.

Additionally, in an embodiment, the battery pack 200 may further include a controller 230 connected to the multiple battery modules 100. The controller 230 may be a Battery Management System (BMS). For example, the controller 230 may be connected to the busbar assembly 120.

The battery pack 200 may include a pack cover member 220 covering the plurality of battery modules 100. The pack cover member 220 may be connected to the pack case 210 by a bolt 133a, or the like, or may be welded to the pack case 210.

In an embodiment, the pack case 210 may include at least one pack venting hole 240. For example, at least one pack venting hole 240 may include a plurality of pack venting holes 240.

The pack venting hole 240 may be a hole penetrating through the pack case 210, and may be a passage through which venting gas discharged through the venting hole 137 formed in the housing 130 of the battery module 100 is discharged to the outside of the battery pack.

The position, number, shape, and the like, of the pack venting hole 240 are not necessarily limited by the present disclosure.

The contents described above are merely examples of applying the principles of the present disclosure, and other components may be further included or substituted and applied without departing from the scope of the present disclosure.

What is claimed is:

1. A battery module, comprising:
at least one battery cell in which at least one electrode lead thereof is exposed to the outside of an outer material including an electrode assembly accommodating region and a terrace region;
at least one busbar assembly connected to the at least one electrode lead;
a housing accommodating the plurality of battery cells and the at least one busbar assembly; and
at least one blocking member disposed to face at least one of the at least one electrode lead or the terrace region.

2. The battery module of claim 1, wherein the at least one blocking member is connected to the at least one busbar assembly, and faces the at least one electrode lead and the terrace region.

3. The battery module of claim 2, wherein the at least one blocking member includes:
a support region connected to the at least one busbar assembly; and
a protruding region protruding in a direction oriented from the support region toward the electrode assembly accommodating region.

4. The battery module of claim 3, wherein in the protruding region, a maximum width in a cross-section of the battery cell in a thickness direction is narrower than a width of the support region.

5. The battery module of claim 3, wherein in the protruding region, a width in a cross-section of the battery cell decreases in a thickness direction toward the electrode assembly accommodating region.

6. The battery module of claim 1, wherein the at least one blocking member is formed of a material having electrical insulation.

7. The battery module of claim 1, wherein the at least one busbar assembly includes:
a busbar member connected to the at least one electrode lead; and
a busbar plate supporting the busbar member and formed of a material having electrical insulation,
wherein the at least one blocking member is connected to the busbar plate and protrudes in a direction from the busbar plate toward the battery cell.

8. The battery module of claim 1, wherein the at least one blocking member is spaced from the battery cell and is not in contact with the battery cell.

9. The battery module of claim 1, wherein a height of the at least one blocking member exceeds a height of the at least one electrode lead.

10. The battery module of claim 1, wherein the housing includes at least one venting hole on a surface facing the at least one busbar assembly, and
a height of the at least one venting hole in the housing is greater than or equal to a height of the at least one busbar assembly.

11. The battery module of claim 10, wherein the housing includes:
a first housing including the at least one venting hole and covering an upper portion of the plurality of battery cells; and
a second housing coupled to the first housing and covering a lower portion of the plurality of battery cells.

12. The battery module of claim 11, wherein a contact region of the first housing and the second housing faces the at least one electrode lead.

13. The battery module of claim 11, further comprising:
a fastening member fixing the first housing and the second housing.

14. A battery pack, comprising:
a pack case; and
a battery module accommodated in the pack case,
wherein the battery module includes:
a plurality of battery cells in which at least one electrode lead thereof is exposed to the outside of an outer material including an electrode assembly accommodating region and a terrace region;
at least one busbar assembly connected to the at least one electrode lead;
a housing accommodating the plurality of battery cells and the at least one busbar assembly; and
at least one blocking member disposed to face at least one of the at least one electrode lead and the terrace region.

15. The battery pack of claim 14, wherein the pack case includes at least one pack venting hole.
